(19) United States
(12) Patent Application Publication
(10) Pub. No.: US 2005/0212256 A1
(43) Pub. Date: Sep. 29, 2005

(54) Anti-jackknifing semi-trailer attachment

(76) Inventor: William R. Cole, Plainfield, IN (US)

Correspondence Address: WILLIAM R. COLE, 8760 S. CR 825 E, PLAINFIELD, IN, 46168, US

(21) Appl. No.: 11/125,492

(22) Filed: May 10, 2005

Related U.S. Application Data
(63) Continuation-in-part of application No. 10/632,314, filed on Aug. 1, 2003.

(51) Int. Cl. B60T 7/12

(52) U.S. Cl. 280/432

(57) ABSTRACT

A system including an anti-jackknifing semi-trailer attachment assembly with a remote control on/off switch and hydraulic cylinder provides system control to a tractor and a trailer connected with a standard fifth-wheel connection, in which the system can be controlled by the driver to allow the moving vehicle to be adjusted to various road conditions in an act to prevent jackknifing

### BACKGROUND OF INVENTON

1. Field of Invention

The scope of this invention is designed for preventing jackknifing between a tractor and trailer, and the method of operating the system. Jackknifing has been ranked 5th most hazardous type of truck accident, accounting for millions of dollars in property damages and more than 5% of the fatal tractor and trailer accidents in the United States. Once the trailer is in line with the tractor or is in a minimal swing with the trailer the anti-jackknifing system can pull a driver out of trouble. The operating system allows a driver to engage and disengage the system with a simple handheld remote control switch.

2. Description of Related Art

Not Applicable

### SUMMARY OF INVENTON

The present system allows the driver to set the control by remote control method implementing the function of the design. As such a jackknife is not permitted to occur when the control system is engaged. The system controls the swing allowing the driver to continue driving the vehicle. The swing of the trailer has a very limited degree of movement in either direction when the system is engaged keeping the tractor and trailer locked from jackknifing.

In accordance with the invention after coupling of the king pin in the center of the fifth wheel v-slot the driver engages the control system and swing limits are engaged.

In the engaged position the anti-jackknife assembly could possibly have lights on both sides of the trailer. The handheld remote control switch would have a simple on/off function, which should be in the on position the majority of time. While the system is engaged the driver is able to change lanes on a highway safely. If needed the driver can apply breaking power and stop within a reasonable amount of space.

The driver should turn the anti-jackknife device off when leaving the highway for rural or town driving loaded or unloaded. Disengaging the anti-jackknifing assembly allows the tractor to maneuver as easily as if it were not in place. The following overview of functions of the system can be installed on new and existing trailers.

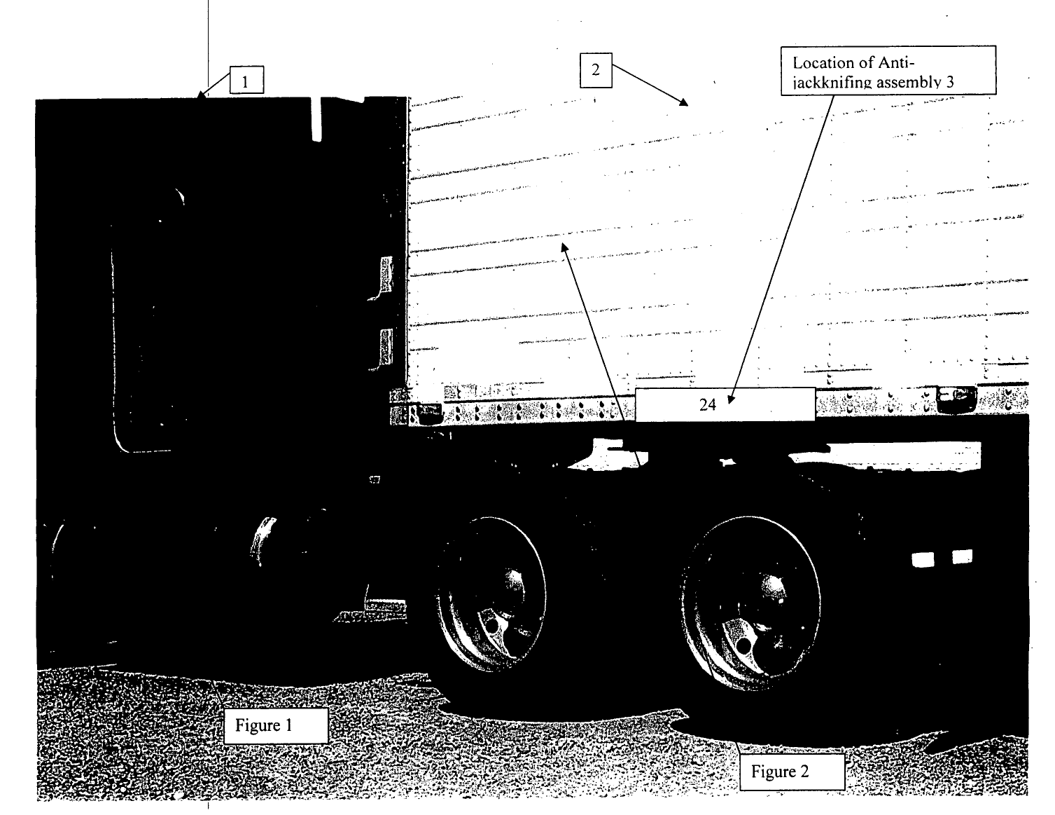

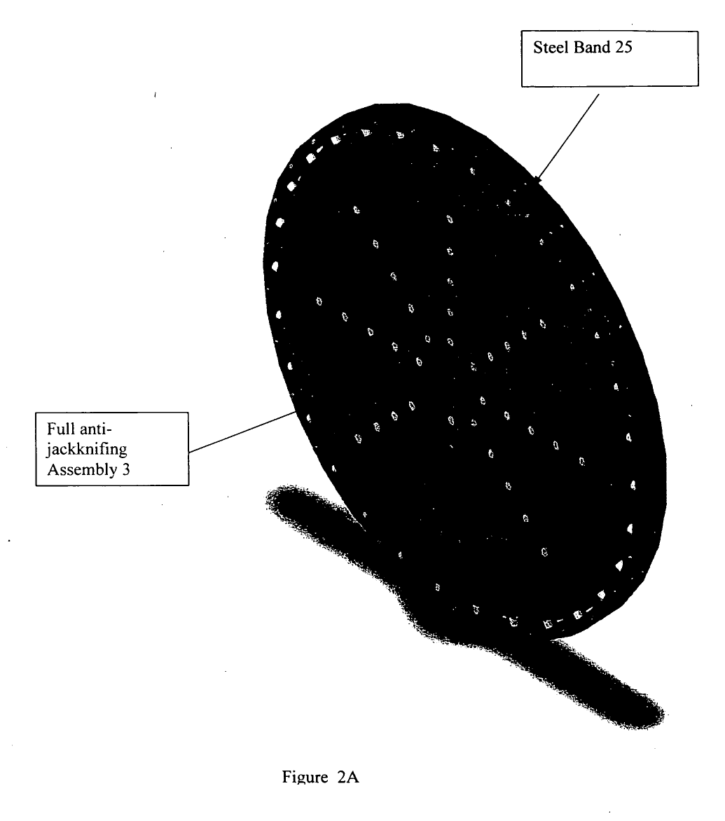

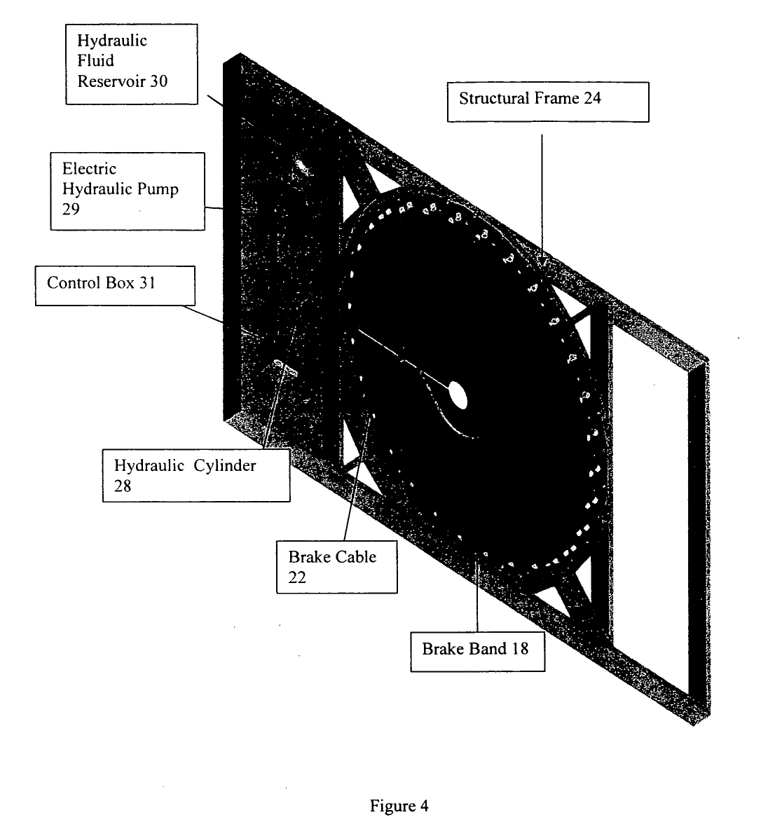

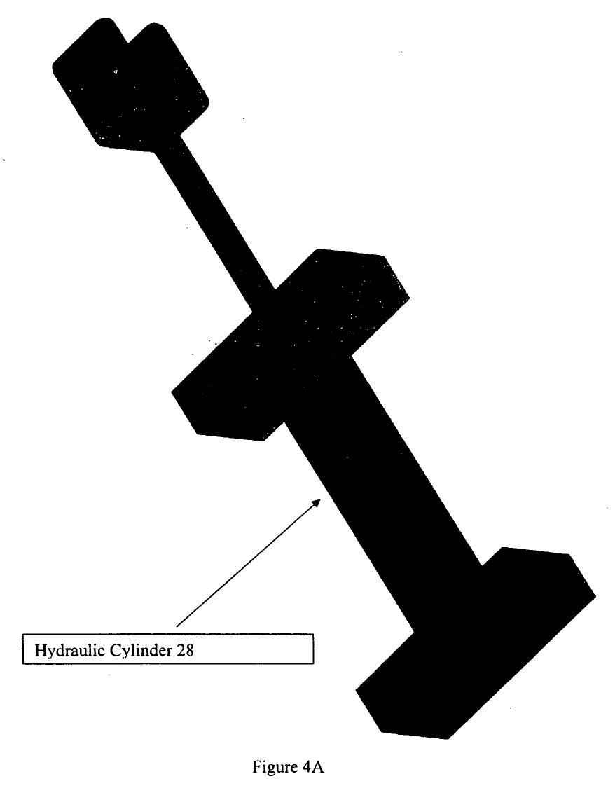

FIG. 1 is a view of the anti-jackknifing assembly that fits inside the structural frame (FIG. 4), which is attached and mounted to the frame of the trailer (FIG. 4). When coupled with the tractor it is located above the fifth wheel (FIG. 2).

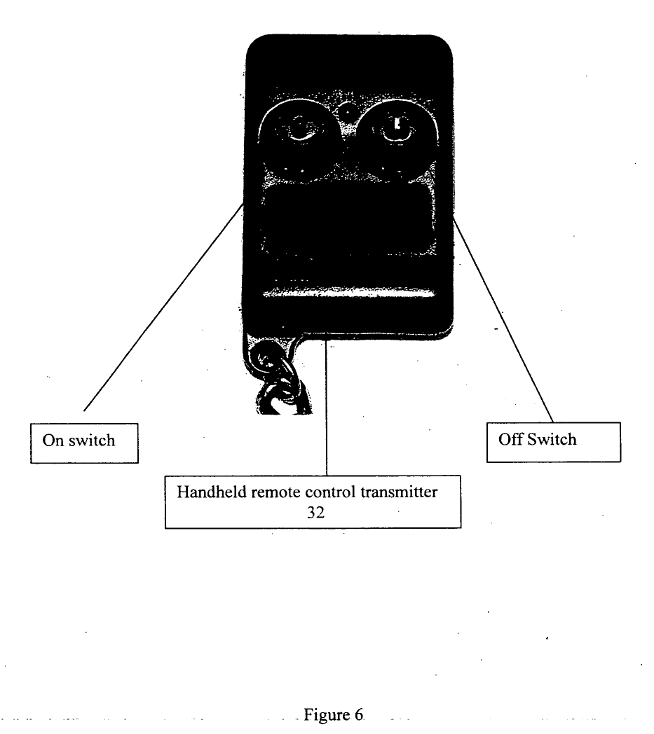

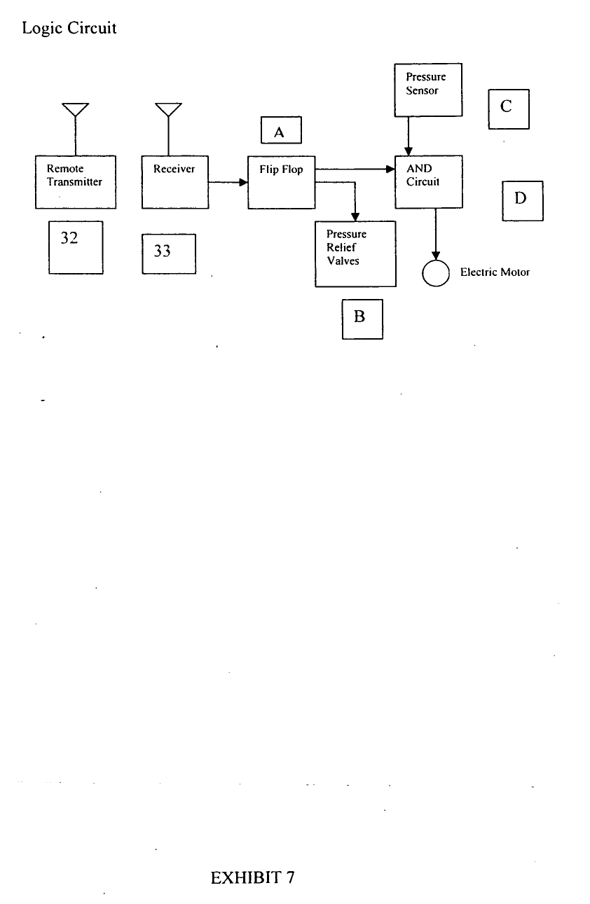

FIG. 6 is a view of the handheld remote control transmitter which sends a signal to the receiver, which in turn operates the anti-jackknife device.

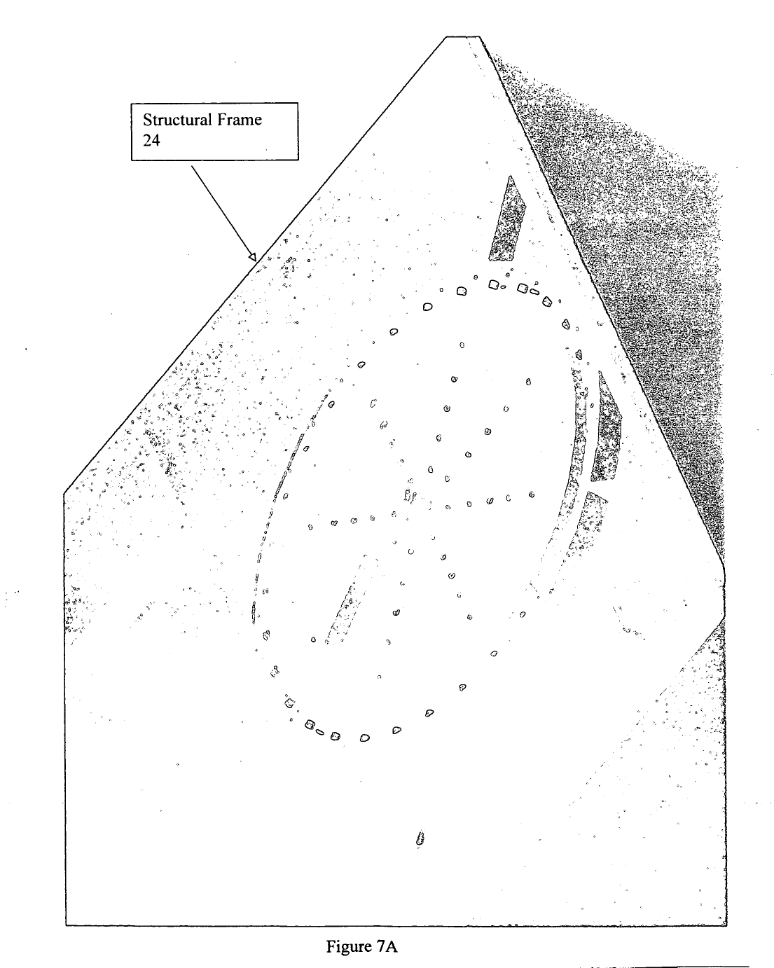

FIG. 7 when the “on” transmit signal is received by the receiver, the receiver circuit energizes the flip flop circuit. The flip flop circuit creates a positive condition on the AND circuit, and a negative condition on the pressure relief valves. This causes the AND circuit to energize the electric motor that drives the hydraulic pump. After three seconds, the pressure sensor will report a positive condition to the AND circuit, allowing the electric motor to continually run until a maximum pressure condition is met, and hydraulic brakes will engage. The electric motor will not run until the system has been completely recycled. The negative condition on the pressure relief valve closes, allowing the hydraulic pump to function.

When the “off” transmit signal is received by the receiver, the receiver circuit will energize the flip flop circuit in a negative condition. The flip flop circuit creates a negative condition on the AND circuit, and a positive condition on the pressure relief valve. This will allow the pressure from the hydraulic line to subside and allow hydraulic brake to disengage.

FIG. 4A is a top view of the hydraulic cylinder 28 which pulls or releases tension on the brake cable 22 by either tightening or loosening the brake band 18. This hydraulic cylinder fits into the structural housing (FIG. 7A).

FIG. 4 is a view of the structural frame of the anti-jackknifing device which holds the anti-jackknife assembly 3, and the hydraulic cylinder 28, the structural support also holds the control box 31 which houses the logic circuit and the receiver. FIG. 7A is a view of the anti-jackknifing device installed on the bottom structural frame 24 of the trailer.

FIG. 1 and FIG. 2 shows a side view of the tractor and trailer which will hold the structural frame of the anti-jackknifing assembly 2A.

The foregoing overview of the functions of the system is implemented by a remote control apparatus which can be installed on new and existing trailers.

### DESCRIPTION OF THE PREFERRED EMBODIEMENTS

Turning now to the drawings in greater detail, the preferred embodiments of the invention is illustrated in FIGS. 1,2,3,4,5,&6 while alternate embodiments are shown in FIGS. 2A, 4A, and 7A. All embodiments are carried on a tractor-trailer rig illustrated in FIG. 1 and FIG. 2.

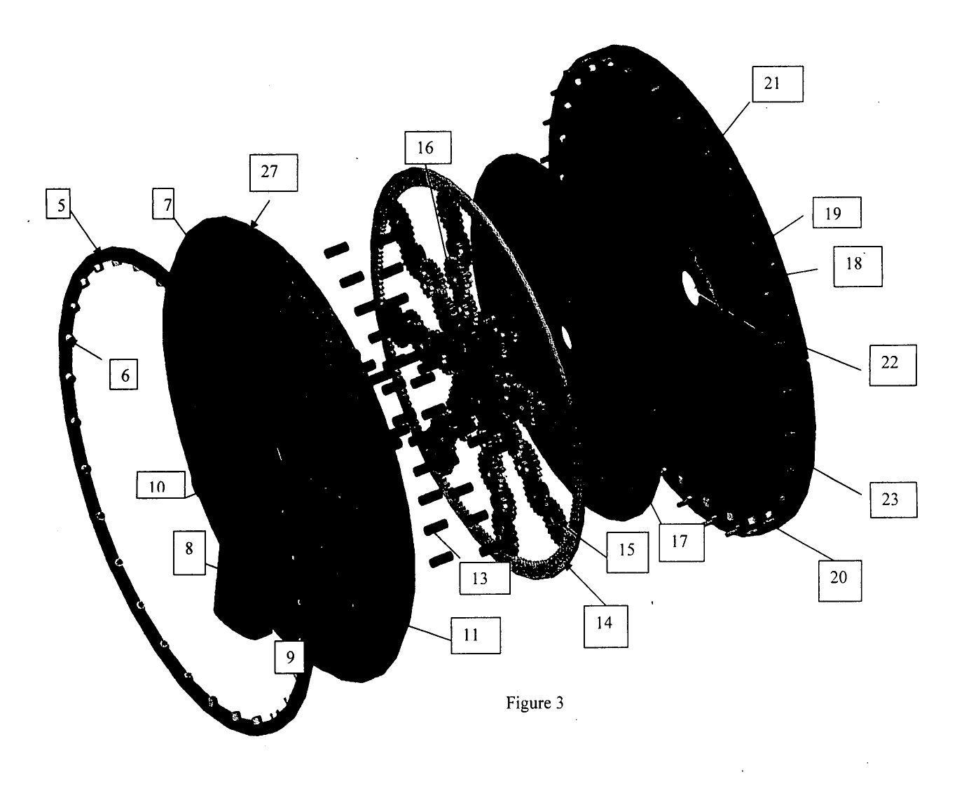

In the preferred embodiments the support frame FIG. 4 is mounted to FIG. 7A which is mounted to bottom of trailer (2.) The full jackknife assembly mounts into the center of the structural frame (24) the anti-jackknife assembly is broken down in FIG. 3. As shown in FIG. 3 the assembly is broken down into an exploded view illustrating all parts of the assembly.

The top structural plate (23) of the anti-jackknife assembly is secured to the structural frame (7A). Vertical rollers (21) are attached to the top structural plate to prevent horizontal movement of the turntable.

The turntable consists of (8, 9, 10, 11, 13, 14, 15, 16 and 17), and when assembled the full anti-jackknife assembly (12) exists.

Horizontal rollers (20) are attached to the top structural plate to facilitate rotation of the turntable. The top structural plate of the turntable (17) presses against the horizontal rollers as aforementioned (20) and presses against the vertical rollers (21).

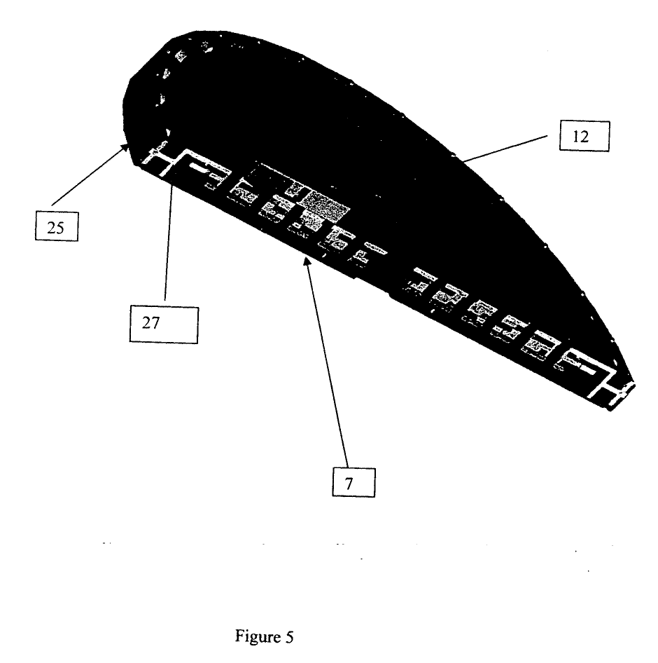

The ring gear (14) is attached to the top structural plate of the assembly with a structural detail shown on FIG. 5 as a steel band (25). The gear pins (13) are attached to the lower plate of the turntable (7). The planetary gears (15) are attached to the pins.

The king pin (10) is inserted through the hole of the bottom plate of the turntable. The brake drum with the gear (16) is attached to the king pin. With the planetary gears (15) attached to the pins (13) the brake drum gear (16) attaches to the king pin making the partially assembled turntable which is inserted inside the ring gear (14).

The top structural plate is (17). The turntable (12) is now placed against the rollers (20) and (21) located as previously mentioned in the top structural plate of the assembly. The bottom horizontal rollers (5) are attached to the top structural plate (23) with steel band (25).

The king pin (10) is inserted through the top structural plate and secured. The wedge (8) is now secured to the bottom structural plate of the turntable by using a spring loaded attachment (9). In addition figure (3) shows the projection (27) of the bottom turntable structural plate (4).

The primary surface of the assembly, when the tractor is coupled with the trailer, which maintains continuous contact with the fifth wheel of the tractor, is the turntable (12). In the center of the device is the king pin (10) which locks into the center of the fifth wheel during the jointing of the tractor and trailer. The turntable (12) is allowed to turn freely on the king pin. The turntable (12) has a (9) spring loaded wedge mount with a (8) sliding wedge attached. The wedge is inserted into the v-shape king pin guide of the tractors fifth wheel during the coupling of the trailer. This locks the turntable to turning motion of the tractors fifth wheel during operation. The turntable projection support (27) ride is suspended in device by three sets of rollers; upper vertical stabilizing rollers (20) and horizontal stabilizing rollers (21) that are mounted to the top structural plate. There is also the lower vertical stabilizing rollers (6) that are attached to the retaining ring (5) which holds the assembly together when fastened to the top structural plate. The top structural plate is attached to the device frame and installed into the framework of the trailer. Therefore making the top structural plate stationary to the trailer, and part of the assembly.

To make this an effective means of an anti-jackknifing ability the device uses a gear network with a braking system, when engaged, locks the turning ability of the top structural plate and turntable in any degree of angle relative to the tractor and trailer. First part of the gear network would be the stationary ring gear (14) which is attached to an elevated ridge inside the top structural plate. The ring gear turns the planetary amplifying gear assembly (15) that is mounted on to the turntable with the use of gear pins (13) inserted into gear pin hole (11) on the turn table. The planetary amplifying gear assembly magnifies the turning motion of the top structural plate and turn table faster and faster until it reaches the center pinion gear/brake drum (16). A few degrees of motion in the turn table and top structural plate could equal several revolutions of the pinion gear/brake drum giving the design the ability to use a low torque braking system for the application.

The braking system is comprised of the pinion/brake drum (16), brake band (18), brake cable (22), hydraulic cylinder (28), electric hydraulic pump (29), hydraulic fluid reservoir (30) and a control system, (FIG. 7).

The remote control handheld transmitter (32) when turned on by the driver sends a signal to the remote control receiver (33) and the flip flop circuit (33A), the pressure relief valve (33B), the pressure sensor (33C), the AND circuit (33D) are all located in the box (31) which is mounted in the structural frame (24) next to the anti-jackknife assembly (2A). In addition when the remote control transmitter (32) is turned on and energizes the electric motor which operates the hydraulic pump (29). The hydraulic fluid reservoir (30) feeds the hydraulic pump (29) which may activate the trailer lights after meeting D.O.T. specified requirements. The overall height of the trailer from the ground to the top of the trailer does not exceed D.O.T. specified requirements.

### DESCRIPTION OF EXHIBITS

Exhibit 1; Tractor Rig
Exhibit 2; Trailer
Exhibit 2A; Full anti-jackknifing assembly
Exhibit 3: Exploded view of anti-jackknifing assembly
Exhibit 4: Structural frame housing the anti-jackknifing assembly
Exhibit 4A; Hydraulic cylinder which operates assembly
Exhibit 5; A cutaway view of the Anti-Jackknife showing specific items
Exhibit 6; A picture of a typical handheld on/off switch to operate the anti-jackknife assembly
Exhibit 7; Logic circuit of how the handheld on/off switch operates
Exhibit 7A; A picture showing underside of trailer with structural frame housing the anti-jackknifing device showing mounting to trailer

1. An anti-jackknife semi-trailer attachment is for use in connection between a tractor having a fifth wheel, and a trailer having a coupling adapted with a support frame mounted to the trailer.

2. The anti-jackknife semi-trailer attachment structure set forth in claim 1 operates by a handheld remote control transmitter which is the means for activation and a possible signal light on the trailer is the means to inform driver that the anti-jackknifing device is energized and in the on position.

3. The anti-jackknife semi-trailer attachment described in claim 1 requires no modification to the tractor, as the device is attached to the trailer and the connection between tractor and trailer utilizes the standard fifth wheel connection.
